(19) United States
(12) Patent Application Publication
(10) Pub. No.: US 2025/0371306 A1
(43) Pub. Date: Dec. 4, 2025

(54) SYSTEMS AND METHODS FOR TIME-SERIES CLASSIFICATION THROUGH RESIDUAL LEARNING

(71) Applicant: Robert Bosch GmbH, Stuttgart (DE)

(72) Inventors: Sepideh KOOHFAR, Dover, NH (US); HyeongSik KIM, San Jose, CA (US); Pongtep ANGKITITRAKUL, Dublin, CA (US)

(21) Appl. No.: 18/676,620

(22) Filed: May 29, 2024

(51) Int. Cl. G06N 3/042; G06N 3/08

(52) U.S. Cl. CPC G06N 3/042; G06N 3/08

(57) ABSTRACT

Methods and systems for enhancing the performance of time series classification models through the introduction of a joint residual-classification framework. This framework aims to address class imbalance issues by effectively integrating residuals with classification model embeddings. In embodiments, categorical ground-truth data is converted into continuous data, and a time series forecasting model is trained to predict residuals that are subsequently integrated into the embeddings of a classifier model. This integration facilitates more accurate model predictions by incorporating additional context specific to the data's characteristics.

### TECHNICAL FIELD

The present disclosure relates to systems and methods for time-series classification through residual learning. In embodiments, this disclosure pertains to data classification and anomaly detection in areas characterized by class imbalance; residual learning is integrated with time series classification models to enhance predictive performance and address the imbalance by refining model accuracy through ensemble and joint modeling techniques.

### BACKGROUND

Anomalies, defined as irregular or unusual occurrences that often necessitate immediate intervention, are prominent across various domains including finance, healthcare, manufacturing, and more. Time series data, which captures information as a series of data points indexed in time order, is crucial for monitoring and predicting such events. The analysis of time series data for anomaly detection involves not just the consideration of individual data points, but also patterns and their temporal connections across the dataset.

Conventional machine learning models like logistic regression, decision trees, and others typically struggle with time series anomaly detection due to their limited ability to understand temporal dependencies that often characterize the data in these applications. Time series data exhibit complex relationships over time that require advanced modeling techniques to accurately capture and utilize them for effective prediction.

The detection of anomalies in time series data is further complicated by the imbalance between the frequencies of normal and anomalous events, often referred to as class imbalance. Regular anomaly detection algorithms are generally biased towards the majority class due to this imbalance, which reduces their effectiveness in identifying rare anomalous events, consequently increasing the likelihood of false negatives. Resampling techniques such as undersampling the majority class or oversampling the minority class have been employed to address this issue; however, these methods often prove inadequate in time series contexts where the temporal order of the data is vital. Alternative methods such as adjusting class weights during the optimization of cost functions have shown potential for more effective handling of class imbalance in time series data, suggesting a need for models that can incorporate such techniques efficiently.

### SUMMARY

In an embodiment, a method for training a time series classification model includes transforming time-series ground-truth data into continuous data, training a time-series forecasting model to predict future values based on the continuous data, and projecting the forecast output into a two-dimensional representation of estimated continuous data. The method involves training a residual model to determine residuals between the continuous data and the estimated continuous data, integrating the residuals into embeddings of the time-series forecasting model, and retraining the model with embedded residuals to minimize cross-entropy loss. Upon convergence of the cross-entropy loss, a trained time series forecasting model configured to predict classifications for time-series data is outputted

In embodiments, a system having a processor and memory including instructions that, when executed by the processor, cause the processor to perform these steps.

In embodiments, a non-transitory computer-readable medium has instructions that, when executed by a processor, cause the processor to perform these steps.

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3 shows a schematic diagram depicting the components and mathematical operations within a time series neural model, illustrating the conversion of input vectors using weight matrices to generate projected output vectors in a formatted matrix structure.

FIG. 4 shows an embodiment of a flowchart including a method for training a time series classification model, accompanied by graphical representations of data transformations and predictions at various steps, such as embedding and normalization of data, model training, residual modeling, and labeling with respective outcomes including accuracy and F1-score metrics displayed.

FIG. 5 is a table showing datasets with corresponding sample counts, event types, and distribution between normal and abnormal classes for each dataset.

FIG. 6 is a table comparing the performance metrics such as accuracy, F1-score, precision, and recall, across three different models for three datasets over a forecasting horizon of 60 units, according to an embodiment.

FIG. 7 illustrates a method for training a time-series classification model with residual learning, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Anomalies are events or occurrences that are unusual or irregular, and they often need immediate attention. These unusual events can manifest across various domains such as electronic mails, finance, healthcare, manufacturing, and more. Time series data is a collection of data samples over time where temporal order of samples plays a crucial role. Analyzing anomalies in time series data goes beyond just looking at individual data points. It involves considering the patterns and connections between events over time. By capturing and understanding these patterns, we can build models that can help predict potential future anomalies. This can be really helpful in detecting and preparing for unusual events before they happen, allowing us to take actions to prevent or minimize their impact.

Simple machine learning models, such as basic decision trees or linear classifiers, are often inadequate for time series classification due to their limited capacity to capture temporal dependencies and patterns within sequential data, particularly non-linear and complex dependencies. Time series data typically exhibit intricate temporal relationships and trends that necessitate more sophisticated models to effectively capture nuances. However, time series anomaly detection faces a significant challenge known as class imbalance. This imbalance arises when anomalies occur rarely in comparison to normal data instances. In practical scenarios, anomalies often represent a small fraction of the overall data, leading to an imbalanced distribution. For example, considering one selected dataset, in vehicular accidents, abnormal data only exists in three percent of all samples. Consequently, standard anomaly detection algorithms, typically designed for balanced datasets, may suffer from reduced sensitivity in detecting anomalies, leading to a high rate of false negatives.

To mitigate the impact of class imbalance, different techniques have been proposed. One of the common approaches is to use resampling techniques to make the data balanced. Resampling techniques are often employed as undersampling and oversampling. Undersampling is the process of reducing the amount of majority class samples, where oversampling aims to increase the amount of minority class. However, none of such techniques can be beneficial for time series dataset where the temporal order of data matters. Given the problems associated with sampling techniques for time series datasets, other techniques such as adjusting the class weights when optimizing the cost function can be considered more feasible. Some have proposed adjusting the class wrights when optimizing the cross entropy loss by either setting the class weight to the inverse of class frequency or learning the weights through optimizations.

Time series anomaly detection can be formulated as follows. Given the observed events in the past from time step t₀−k to t₀, an objective is to predict the series of normal/abnormal events in the future from time step t₀ to t₀+τ. Mathematically, given the time series of past observations denoted as

$$X = {\{ {x}_{t} \}}_{t = {t}_{0} - k}^{{t}_{0}} ,$$

the future series of normal/abnormal events denoted as

$$Y = {\{ {y}_{t} \}}_{t = {t}_{0}}^{{t}_{0} + τ}$$

is predicted. Each xₜ contains the categorical value of the type of an event, along with other static information such as time and the location in which xₜ has been collected. However each yₜ represents a scalar value of whether the predicted event classifies as abnormal (denoted as 1) or normal (denoted as 0).

The categorization of future time series prediction involves two distinct challenges: forecasting and classification. In both scenarios, historical sequences of observations are leveraged to make predictions about what lies ahead. Time series forecasting entails predicting continuous values, resembling a regression problem. On the other hand, time series classification involves predicting class labels, akin to a classification problem. For discrete data, binary classification in time series involves utilizing the previous k categorical observations, represented as

$$X = {\{ {x}_{t} \}}_{t = {t}_{0} - k}^{{t}_{0}} ,$$

to categorize future predictions into either class 0 or class 1, denoted as

$$y = {\{ {y}_{t} \}}_{t = {t}_{0}}^{{t}_{0} + τ} ,$$

where yₜ ∈0, 1. In scenarios such as anomaly or rare event detection, the label 1 is assigned to the rare class, while the label 0 is assigned to the normal or abundant class. Every time series forecasting model can be modified to suit classification tasks, wherein future predictions are translated into class labels rather than continuous values. As a result, a focus of this disclosure lies in utilizing and improving a cutting-edge time series forecasting model to address the problem of anomaly detection.

Transformer model architectures were initially introduced to handle sequence-to-sequence tasks, such as text generation, translation, and summarization, among others. Textual data, composed of discrete or categorical elements, treats words as fundamental units, capturing the complex structure and meaning of language. Transformers incorporate an attention mechanism that identifies similarities between different words within the same sequence, enabling the model to better understand contextual relationships and dependencies for more accurate predictions of the next word or element in the sequence. The resemblance of time series data to text/sequence data renders transformer-based models well-suited for time series prediction tasks. Autoformer represents a transformer-based model specifically designed for time series forecasting. Its primary objective is to mitigate the quadratic memory and time complexity drawbacks that are inherent in standard transformers. This is accomplished by identifying correlations among sub-series, eliminating the necessity of attending to each individual time step. A focus of this disclosure is to leverage the Autoformer model to tackle the challenge of time series anomaly detection, wherein the task is reformulated into a binary classification problem. Even though one of the state-of-the-art time series forecasting models is employed, an aim of this disclosure is to construct an architecture that is not tied to any particular model.

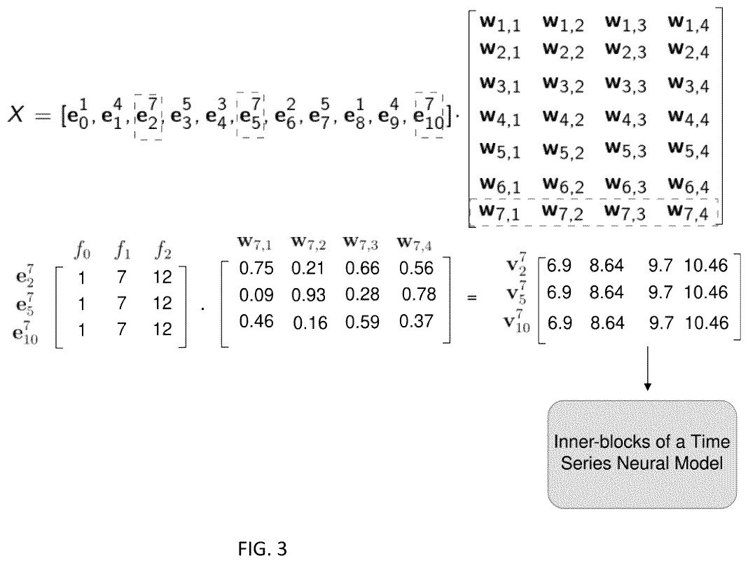

Training neural network models generally involves the process of minimizing a loss function by calculating gradients and adjusting parameters in the direction opposite to the gradient to locate the minimum of the loss function. Typically, this loss function exhibits the characteristics of a convex function, meaning it possesses a global minimum. However, computing gradients necessitates the continuity of the loss function, which, in turn, requires the input data to be continuous in nature. Hence, for categorical or discrete data, there arises a need to map it into a continuous space, where each vector or embedding corresponds to a distinct word or entity. FIG. 3 illustrates this mapping process according to an embodiment.

Each individual entity, characterized by a unique combination of: 1) event type, 2) abnormal or normal status, and 3) location, is mapped into a continuous space using a weight vector embedding approach. In simpler terms, a set of n distinct entities, denoted as ε={e₁, e₂, . . . eₙ}, is projected into a continuous space with a dimensionality of d. This transformation is accomplished by training a weight matrix W ∈ [symbol] ^{n×d}, where d represents the desired dimension size. This transformation is achieved by multiplying each entity with the corresponding row in the weight matrix: vᵢ=eᵢ·Wᵢ, where each vᵢ ∈ [symbol] ^{d}. Therefore, neural network models including Autoformer for time series classification receive an input sequence X and create a series of vector embeddings, where these embeddings are further consumed by the inner-blocks of the neural model to produce the final predictions. These predictions are mapped to a series of two dimensional vector embeddings using multi-layer perceptron style projections, where each dimension represents the probability of belonging to the normal or abnormal class. Time series forecasting models are trained to minimize the cross entropy loss with respect to the ground-truth. Cross-entropy loss, also known as log loss, is commonly used in classification tasks to measure the dissimilarity between predicted probabilities and actual labels. For a single data point, denote the true label as y (0 or 1), and the predicted probability for the positive class (class 1) as p. The cross-entropy loss is given by:

$$CrossEntropyLoss = - {\sum }_{t = {t}_{0}}^{{t}_{0}} {y}_{t} \cdot log ( {p}_{t} ) + ( 1 - {y}_{t} ) \cdot log ( 1 - {p}_{t} ) \qquad ( 1 )$$

where y denotes True label (0 or 1) and p denotes the predicted probability for the positive class. Cross-entropy loss penalizes large differences between the predicted probability and the true label. When y=1, the second term (1−y) log(1−p) becomes 0, and the loss only depends on −log(p), encouraging the predicted probability to be close to 1. Similarly, when y=0, the first term y·log(p) becomes 0, and the loss only depends on −log(1−p), encouraging the predicted probability to be close to 0.

During the inference process, the trained time series classification model f(.) takes previous observations

$$X = {\{ {x}_{t} \}}_{t = {t}_{0} - k}^{{t}_{0}}$$

and produces the final embeddings representing the sequence of next τ steps denoted as

$${F}_{c} = {\{ {f}_{c , t} \}}_{t = {t}_{0}}^{{t}_{0} + τ} .$$

The embeddings F_{c} are then projected using multi-layer perceptron style projections to produce the probability distribution over classes for future τ predictions denoted as P=proj(F_{c}). Finally, to predict whether an anomaly occur over the sequence of future time steps (t₀, t₀₊₁, . . . t_{0+τ}), the most likely class is selected using the argmax operation:

$${\hat{y}}_{t} = arg {max}_{i ∈ \{ 0 , 1 \}} ( {P}_{t , i} ) for t ∈ ( {t}_{0} , … {t}_{o} + τ ) \qquad ( 2 )$$

Therefore, in view of the description above, and according to embodiments disclosed herein, methods and system are provided for enhancing time series classification model performance through the use of residual learning techniques. In the following details of each step is provided, shedding light on the methods employed to convert categorical ground-truth data into continuous values, train a time series forecasting model, and integrate residuals into classification model embeddings. Also provided are insights into the benefits and improvements offered by this approach, supported by empirical results from experiments on various datasets.

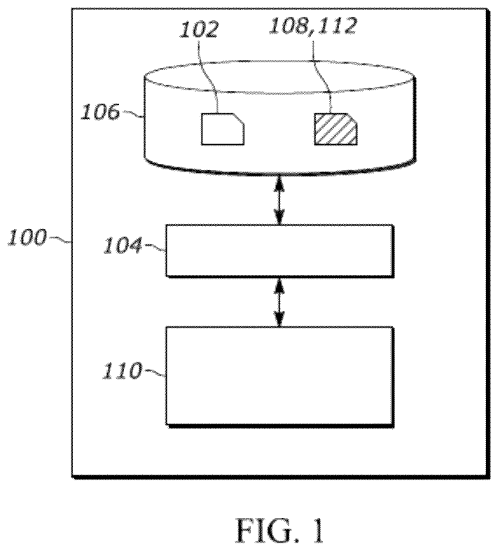

Machine learning and neural networks are an integral part of the inventions disclosed herein. FIG. 1 shows a system 100 for training a neural network, e.g. a deep neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106.

The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation and a part of the input of the stack of layers. The processor subsystem 110 may be further configured to iteratively train the neural network using the training data 102. Here, an iteration or session of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network; this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may, during or after the training, be replaced at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

The system 100 shown in FIG. 1 is one example of a system that may be utilized to train the machine learning models described herein.

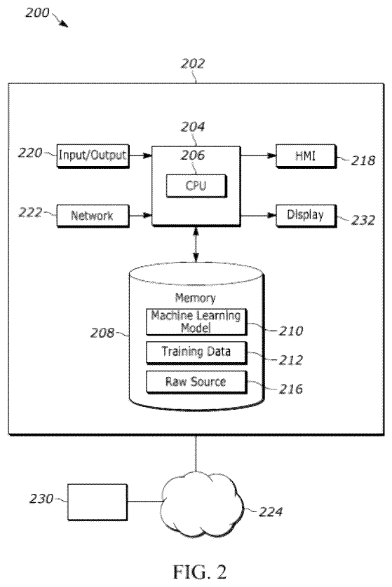

FIG. 2 depicts a system 200 to implement and/or execute the machine-learning models described herein, for example the residual learning models discussed. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuitry or BUS networks to transfer information to or between the processor(s) and storage. For example, the I/O interface 220 can include digital I/O logic lines which can be read or set by the processor(s), handshake lines to supervise data transfer via the I/O lines, timing and counting facilities, and other structure known to provide such functions. Examples of input devices include a keyboard, mouse, sensors, touch screen, etc. Examples of output devices include monitors, touchscreens, speakers, head-up displays, vehicle control systems, etc. The I/O interface 220 may include additional serial interfaces for communicating with external devices (e.g., Universal Serial Bus (USB) interface). The I/O interface 220 can be referred to as an input interface (in that it transfers data from an external input, such as a sensor), or an output interface (in that it transfers data to an external output, such as a display).

The computing system 202 may include a human-machine interface (HMI) device 218 that may include any device that enables the system 200 to receive control input. The computing system 202 may include a display device 232. The computing system 202 may include hardware and software for outputting graphics and text information to the display device 232. The display device 232 may include an electronic display screen, projector, speaker or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time, a heart rhythm, etc.), and raw or partially processed sensor data (e.g., radar map of objects). In some examples, the machine-learning algorithm 210 may be a neural network algorithm (e.g., deep neural network) that is designed to perform a predetermined function. For example, the neural network algorithm may be configured in automotive applications to identify street signs or pedestrians in images. The machine-learning algorithm(s) 210 may include algorithms configured to operate one or more of the machine learning models described herein, including the time-series forecasting model and residual model.

The computing system 202 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include input images that include an object (e.g., a street sign). The input images may include various scenarios in which the objects are identified. The training dataset 212 may also include the text description of the scene that corresponds to the images detected by the vehicle sensors (e.g., “a 25 mph speed limit sign”).

The machine-learning algorithm 210 may be operated in a learning mode using the training dataset 212 as input. The machine-learning algorithm 210 may be executed over a number of iterations or sessions using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data. In the context of the VLP model described herein, a loss between the predicted trajectory of the autonomous vehicle and the ground truth trajectory of the vehicle can be determined, and the VLP model can be trained to reduce this loss, e.g. to convergence.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of agents in video images, annotate the occurrences, and/or command the vehicle to take a specific action (planning) based on the locational data of the agent (perception) and the predicted future movement/location of the agent (prediction). The machine-learning algorithm 210 may be programmed to process the raw source data 216 to identify the presence of the particular features. The machine-learning algorithm 210 may be configured to identify a feature in the raw source data 216 as a predetermined feature (e.g., road sign, pedestrian, etc.). The raw source data 216 may be derived from a variety of sources. For example, the raw source data 216 may be actual input data collected by a machine-learning system. The raw source data 216 may be machine generated for testing the system. As an example, the raw source data 216 may include raw video images from a camera. The raw source data 216 can be time series data, including a collection of data samples over time. This can be generated from microphones, pressure sensors, EKGs, etc.

As described above, this disclosure, methods and system are provided for enhancing time series classification model performance through the use of residual learning techniques. First, this disclosure explains increasing a model's resiliency through residual learning. Then, the following concepts are discussed: converting categorical ground-truth data to continuous data; training the time series forecasting-residual model; and integrating residuals with the classifier model's embeddings. Results of experiments are also provided.

This disclosure proposes that a time series classification model's performance can be enhanced by building more contextualized and informative embeddings. Essentially, any time series classification model's output is an embedding that is optimized by minimizing the loss between the model's output and true labels. However, the performance of a classification model can be significantly boosted by augmenting the embeddings with residual learning techniques, particularly when the ground truth consists of additional information in the form of categorical or continuous.

Residual learning, a concept popularized by residual neural networks, ResNets, involves learning the residual (difference) between the predicted output and the true output. This approach can be utilized in time series classification by considering the categorical/continuous information that accompanies the ground truth. The residual neural model can be designed to predict the residual transformation needed to augment the embedding with information that can more accurately resemble the ground-truth.

By incorporating residual learning in this manner, the classification model's performance can be boosted by adding residuals that are trained to further minimize the distance between ground-truth and the predictions. This approach is particularly effective when the ground truth encompasses additional information beyond a simple binary (0 or 1) label class. Therefore, this disclosure aims to exploit the additional event type that accompanies the ground-truth to train the residual model. This approach allows the model to capture intricate patterns related to the categorical attributes, leading to embeddings that are not only contextually richer but also better aligned with the ground-truth.

According to an embodiment, first categorical ground-truth is converted to continuous data. Learning residuals requires the ground-truth to be in continuous space. Therefore, the categorical information including binary class label and event-type associated with each binary class denoted as y=y₀ ∈{0,1}, y₁ ∈{c₁, c₂, . . . cₘ} is converted to continuous data, where m denotes the total number of event types. There are several methods available for transforming categorical data into continuous data. In one embodiment, Exponential Smoothing is utilized. This technique generates continuous values by computing a weighted average of neighboring data points, with closer points being assigned higher weights compared to those farther away. This approach can be formulated as follows:

$${y}^{count} = {y}_{i} , t = \frac{{y}_{1} + ( 1 - a ) {y}_{1} , t - 1 + … + ( 1 - a ) {y}_{i} , 0}{{1 + ( 1 - a ) + {( 1 - a )}^{2} + … + ) 1 - a )}^{t}} \qquad ( 3 )$$

$$for i ∈ \{ 0 , 1 \} and t ∈ ( {t}_{0} , … , {t}_{0} + τ )$$

where α is the smoothing factor. This α variable is set to 2/3 in an embodiment. In this way, the categorical information is converted into continuous data using the exponential smoothing technique. This allows one to work with continuous values for learning residuals when dealing with categorical data.

Learning the residuals may require first training a time series forecasting model that given inputs X predicts the forecasts for the next future τ steps denoted as

$${F}_{f} = {\{ {f}_{f , t} \}}_{{t}_{0}}^{{t}_{0} + τ} .$$

The forecasts F_{f} are then projected to a two-dimensional space to represent the estimated values of y^{count}. The output of the forecasting model is optimized using the L₁ loss as follows:

$${Loss}_{F} = \vert {y}^{count} - proj ( {F}_{f} \vert \qquad ( 4 )$$

After training the forecasting model, we train a residual model to minimize the residual (difference) between the forecasts of the forecasting model F and the ground-truth y^{count}. Given the input sequence X, the time series forecasting residual model denoted as r(.) predicts the residuals for the next future time steps denoted as

$$R = {\{ {r}_{t} \}}_{{t}_{0}}^{{t}_{0} + τ} .$$

Similar to the forecasting model, the residuals R are then projected to a two-dimensional space to represents the estimated residuals of y^{count}. The residual is learned by minimizing the L₁ loss as follows:

$$Residual = {y}^{count} - proj ( {F}_{f} ) \qquad ( 5 )$$

$${Loss}_{R} = \vert Residual - proj ( R ) \vert \qquad ( 6 )$$

Then, in embodiments, residuals are integrated with the classifier model's embedding. The training of the time series binary classification model is enhanced by integrating residuals into the embeddings of the classification model. This serves as a boosting technique that aids the classification model in cases where it falls short to accurately align with the ground-truth labels. This can be achieved by predicting the embeddings Fc of the classification model followed by predicting the residuals of Fc using the trained residual forecasting model:

$$f ( X ) = {F}_{c} \qquad ( 7 )$$

$$r ( {F}_{c} ) = {R}_{c} \qquad ( 8 )$$

$$P = proj ( {F}_{c} + {R}_{c} ) \qquad ( 9 )$$

The trained residual forecasting model predicts the residual the prediction F_{c}, of the classification model to accommodate for when the classification models fails to resemble the behavior of the target variable. Finally the predictions P are optimized by minimizing the cross-entropy loss in Equation (1) with respect to the target class label

$$y = {\{ {y}_{t} \}}_{{t}_{0}}^{{t}_{0} + τ} ,$$

where each yₜ ∈0,1.

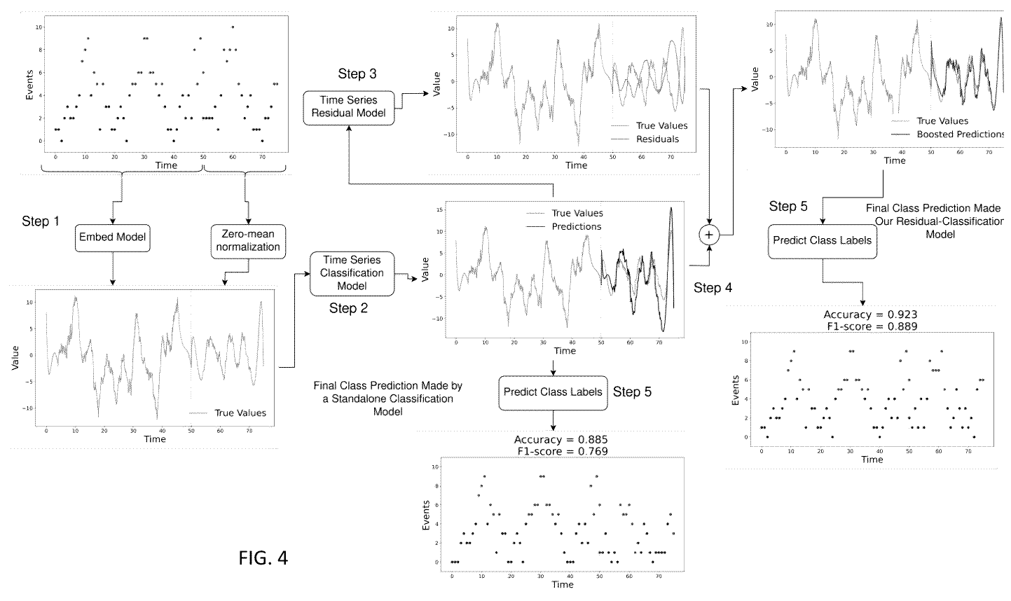

FIG. 4 illustrates the overall framework of the proposed residual-classification model, according to an embodiment. In the illustrated embodiment, the task is to predict the class labels (e.g., normal or abnormal) of 25 time steps into the future by receiving the past 50 observations. The time series consists of 10 different events where events with type greater than four are considered as abnormal and normal otherwise. As shown at Step 1, the inputs

$${X}_{t = 0}^{50}$$

are mapped to

$${V}_{t = 0}^{50}$$

using the embeddings model, and the ground-truths

$${Y}_{t = 51}^{75}$$

are converted to continuous data

$${Y}_{count , t = 51}^{75}$$

using zero-mean normalization, as an example. As shown at Step 2, the time series classification model receives

$${V}_{t = 0}^{50}$$

and predicts F_{c}, where the residual model (Step 3) predicts the residual of the classification model's prediction denoted as Fᵣ Next at Step 4, predictions are boosted by merging the predictions F_{c} and the residual Fᵣ. Finally at Step 5, the forecasts F_{c} (predicted by the standalone classification model) and forecasts F_{c}+Fᵣ (predicted by our residual-classification model) are employed to predict the class label of future time steps using Equation (2) above. Predicted class labels using the disclosed residual-classification model shows higher accuracy and f1-score.

The performance of the time series classification models have been evaluated on three public labeled time series datasets: US Accidents (US-ACC), Severe Weather Data Inventory (SWDI), and 2 W Dataset-Undesirable Events in Oil Wells.

US-ACC is a countrywide car accident dataset that covers 49 states of the USA. The accident data were collected from February 2016 to March 2023. This dataset contains a severity attributes, a number between 1 and 4, where 1 indicates the least impact on traffic, whereas 4 indicates the most impact on traffic. Target labels are created by classifying accidents with severity from 1 to 3 as normal (not fatal) and accidents with severity 4 as abnormal (fatal).

SWDI is an integrated dataset of severe data records of the USA. The dataset available on Kaggle was utilized, containing records from the year 2015 in SWDI. These records are sourced from the National Climatic Data Center archive and encompass a wide array of weather phenomena. This datasets contains the information of size and the probability of severity of each sever event. Events were classified based on the probability of severity from 1 to 10, with 1 being the least severe and 10 being the most severe event. Target variables are created by classifying events with severity from 1 to 5 as normal and 5 to 10 as abnormal.

The 3 W Dataset is a comprehensive dataset of simulated and hand-drown instances of eight types of undesirable events characterized by eight process variables spanning from year 2012 to 2018. This dataset also contains normal events that are not dangerous or fatal. Undesirable events with types from 1 to 8 are considered as abnormal and events with type 0 are considered as normal.

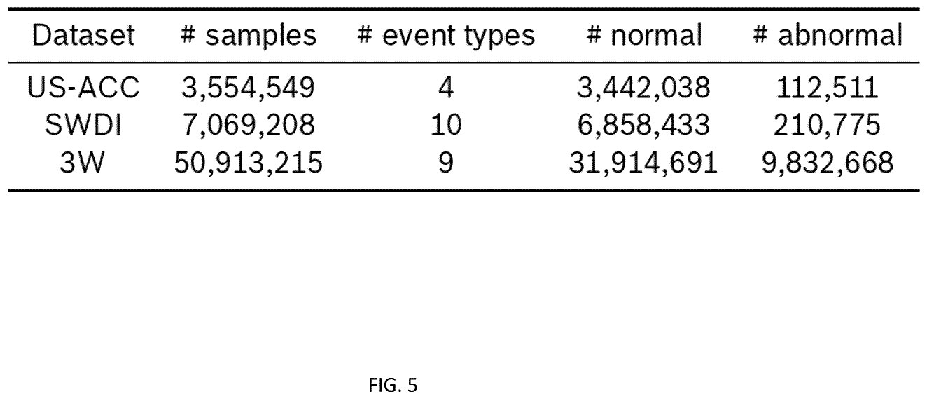

The summary of each of these three datasets after pre-processing is provided in FIG. 5. Each sample in all the dataset contains the information of the type of event, time, and a categorical id to partition samples. For example, in the US-ACC dataset, the Zip-code information for each accident's location was used to categorize the data. This categorization ensures the integrity of time series accidents in one particular location and preventing any interference from unrelated data from distant locations, such as accidents occurring in another state.

In embodiments, the models described herein were developed using the PyTorch deep learning framework, although other frameworks can be used. Models are trained by minimizing the Cross-Entropy loss. The class weights of the Cross-Entropy loss are adjusted with respect to the number of classes, where the class with less frequency (abnormal class) gets a higher importance. This way, the effect of class imbalance on the optimization process is reduced. The warm-up steps of the optimization are tuned to achieve better convergence. Model size (dimensionality of latent space) for all models is set to 32. The batch size is set to 512 and use 8-head attention for all attention-based models. One stack of encoder and decoder is used for the classification and residual models.

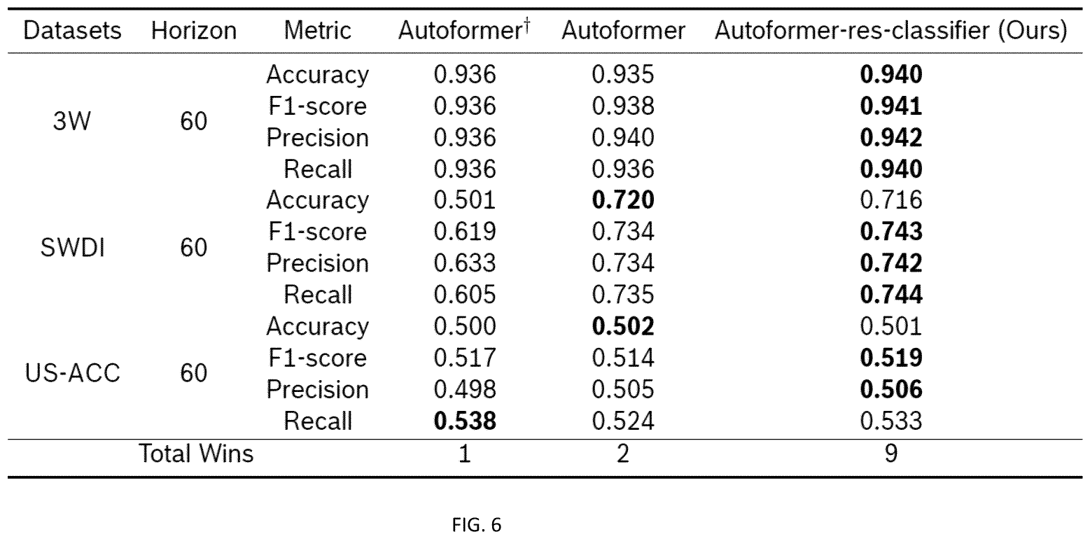

FIG. 6 summarizes the evaluation results on all three datasets, results are reported as balanced accuracy, weighted f1-score, weighted precision, and weighted recall. The base model and the proposed model disclosed herein are evaluated on their ability to predict the potential occurrence of anomaly for the future 60 steps. In comparison to the base classification model, the proposed trained classification model disclosed herein outperforms in 92% of the cases (“Total Wins”). The success of the residual-classification model disclosed herein stems from the division of responsibilities arising from the residual framework. As a result, the classification model is focused on predicting overarching patterns and trends, while a dedicated residual model takes care of the intricate final particulars. This leads to an overall enhancement in accuracy and robustness of the model.

This disclosure studies the multi-horizon time series classification problem and propose an end-to-end residual classification framework, which hinges on the principles of a residual-ensemble structure. In the proposed framework, the classification model is encouraged to focus on predicting the overarching patterns, while the residual model is responsible to intricate final particulars. This ultimately leads to a more resilient classification model. Experiments show the effectiveness of this approach across three real-world datasets. Integrating predictions with residuals is shown to be advantageous over a base classification model.

As disclosed herein, classification models are configured to categorize input data into predefined classes (e.g., normal, abnormal) based on learned features from training datasets. It distinguishes between different categories or classes by locating boundaries within multi-dimensional data, typically using algorithms that minimize error between predicted and actual classes during training. Residual learning, when integrated into a classification model, enhances its performance by allowing the model to focus on learning deviations between its predictions and the actual data, rather than direct estimation. This is beneficial in scenarios where classes are imbalanced or data is complex, as the model adapts to minor variations and nuances more effectively, thus leading to an increase in overall accuracy and robustness of the classification task. Residual learning specifically targets improving the model's prediction capabilities by adding context and depth to the embeddings used for class differentiation, enabling a more nuanced understanding and handling of data.

It should be noted that this disclosure should not be limited solely to scenarios where the ground-truth data is initially in a non-continuous format. There exist applications where the ground-truth data may inherently be in a continuous form, such as audio signals captured from microphones. In such scenarios, the step of transforming the data might involve different preprocessing techniques aimed at enhancing the data's characteristics for improved model training effectiveness.

Once trained, the disclosed time-series forecasting model integrated with residual learning can be deployed in a variety of settings to identify anomalous data points within time-series data effectively. For instance, in manufacturing processes, the model can monitor equipment performance in real time, alerting operators to deviations from normal operational patterns that may indicate potential failures or inefficiencies. This allows for proactive maintenance and can significantly reduce downtime and maintenance costs. Additionally, in the context of patient monitoring, the model can be applied to continuously collected health data, such as heart rate or blood pressure time series. The model's ability to detect anomalous patterns can assist in early diagnosis of potential health issues, enabling timely intervention and improving patient care outcomes. In the context of financial markets, the model can enhance trading strategies. For example, the model can be utilized to monitor and predict unusual market movements, providing traders and financial analysts with advanced warning of potential volatility or anomalies in stock prices, currency values, or commodity prices. This capability enables more informed decision-making, potentially leading to improved trading outcomes and risk management. By continuously analyzing the financial time series data, the model can learn to detect subtle, yet critical, signs of market shifts that could precede significant events, thus providing a valuable tool for proactive financial analysis. In the context of electronic communication, the trained model can be deployed to enhance spam detection in electronic mail (email) systems. For example, the model can analyze the sequence of incoming emails over time to detect unusual patterns that may indicate spam or other malicious intent. By continuously monitoring email traffic, the model can learn to recognize and flag emails that deviate from typical patterns observed in regular correspondence.

For instance, sudden increases in email frequency, peculiar language usage, or anomalous sending patterns that differ significantly from the user's typical behavior or that of their contacts could all be effectively identified as anomalies by the model. This capability can help to prevent spam and phishing attacks, thereby enhancing the security and reliability of email communications. By assessing the characteristics of each email within the context of ongoing correspondence, the model ensures dynamic adaptation to new spam strategies, offering robust protection against a wide range of email-borne threats.

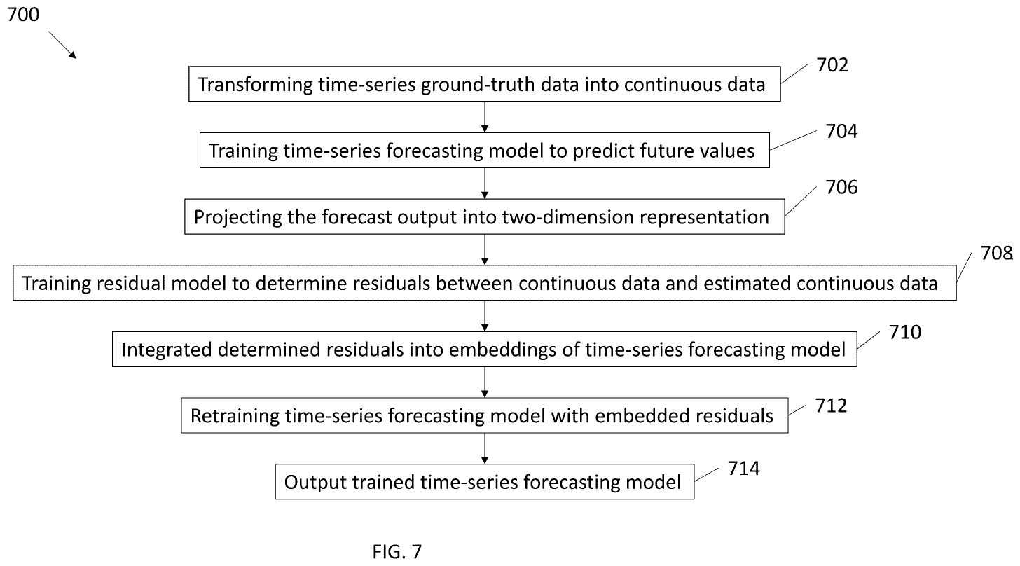

FIG. 7 illustrates a method 700 for training a time-series classification model according to an embodiment. The method may be trained and executed using the teachings herein, for example the systems described with reference to FIGS. 1-2.

At 702, time-series ground-truth data is transformed into continuous data. As an example, data points representing certain events (e.g., health-related events such as heart beats, financial data points, and the like) are transformed into a continuous data. An example of this is shown in Step 1 of FIG. 4 and described above.

At 704, a time-series forecasting model is trained to predict future values based on the transformed continuous data. The training of this time-series forecasting model yields a forecast output. This can be achieved upon convergence, for example. Then, at 706, the forecast output is projected into a two-dimensional representation of estimated continuous data.

At 708, a residual model is trained to determine residuals (e.g., differences) between the continuous data and the estimated continuous date. These residuals are integrated into embeddings of the time-series forecasting model at 710. With those embeddings, the time-series forecasting model is retrained at 712 to minimize cross-entropy loss associated with the time-series forecasting model. When the cross-entropy loss is minimized, for example upon convergence, a trained time-series forecasting model is yielded at 714. This trained model is configured to predict classifications for time-series data.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for training a time series classification model, the method comprising:
transforming time-series ground-truth data into continuous data;
training a time-series forecasting model to predict future values based on the transformed continuous data, yielding a forecast output;
projecting the forecast output into a two-dimensional representation of estimated continuous data;
training a residual model to determine residuals between the continuous data and the estimated continuous data;
integrating the determined residuals into embeddings of the time-series forecasting model;
retraining the time-series forecasting model with the embedded residuals to minimize cross-entropy loss associated with the time-series forecasting model; and
upon convergence of the cross-entropy loss, outputting a trained time-series forecasting model configured to predict classifications for time-series data.

2. The method of claim 1, wherein the classifications predicted by the trained model are binary and comprise normal data and abnormal data.

3. The method of claim 1, wherein the transforming includes utilizing exponential smoothing that assigns weights to data points in the time-series ground-truth data for calculating the continuous data.

4. The method of claim 1, further comprising projecting residuals from the model to a two-dimensional space.

5. The method of claim 4, wherein the projecting of residuals includes utilizing a numerical optimization to align the projected residuals with the two-dimensional representation of estimated continuous data values.

6. The method of claim 1, further comprising adjusting weights of a cross-entropy loss function based on class frequency to mitigate effects of class imbalance during the retraining of the time-series forecasting model.

7. The method of claim 1, wherein the time series classification model utilizes a transformer-based architecture to perform sequence-to-sequence prediction tasks.

8. A system for training a time series classification model, the system comprising:
a processor; and
memory containing instructions that, when executed by the processor, cause the processor to perform the following:
transforming time-series ground-truth data into continuous data;
training a time-series forecasting model to predict future values based on the transformed continuous data, yielding a forecast output;
projecting the forecast output into a two-dimensional representation of estimated continuous data;
training a residual model to determine residuals between the continuous data and the estimated continuous data;
integrating the determined residuals into embeddings of the time-series forecasting model;
retraining the time-series forecasting model with the embedded residuals to minimize cross-entropy loss associated with the time-series forecasting model; and
upon convergence of the cross-entropy loss, outputting a trained time-series forecasting model configured to predict classifications for time-series data.

9. The system of claim 8, wherein the classifications predicted by the trained model are binary and comprise normal data and abnormal data.

10. The system of claim 8, wherein the transforming includes utilizing exponential smoothing that assigns weights to data points in the time-series ground-truth data for calculating the continuous data.

11. The system of claim 8, wherein the instructions, when executed by the processor, further cause the processor to perform:
projecting residuals from the model to a two-dimensional space.

12. The system of claim 11, wherein the projecting of residuals includes utilizing a numerical optimization to align the projected residuals with the two-dimensional representation of estimated continuous data values.

13. The system of claim 8, wherein the instructions, when executed by the processor, further cause the processor to perform:
adjusting weights of a cross-entropy loss function based on class frequency to mitigate effects of class imbalance during the retraining of the time-series forecasting model.

14. The system of claim 8, wherein the time series classification model utilizes a transformer-based architecture to perform sequence-to-sequence prediction tasks.

15. A non-transitory computer readable medium storing instructions that, when executed by a processor, cause the processor to perform:
transforming time-series ground-truth data into continuous data;
training a time-series forecasting model to predict future values based on the transformed continuous data, yielding a forecast output;
projecting the forecast output into a two-dimensional representation of estimated continuous data;
training a residual model to determine residuals between the continuous data and the estimated continuous data;
integrating the determined residuals into embeddings of the time-series forecasting model;
retraining the time-series forecasting model with the embedded residuals to minimize cross-entropy loss associated with the time-series forecasting model; and
upon convergence of the cross-entropy loss, outputting a trained time-series forecasting model configured to predict classifications for time-series data.

16. The non-transitory computer-readable medium of claim 15, wherein the classifications predicted by the trained model are binary and comprise normal data and abnormal data.

17. The non-transitory computer-readable medium of claim 15, wherein the transforming includes utilizing exponential smoothing that assigns weights to data points in the time-series ground-truth data for calculating the continuous data.

18. The non-transitory computer-readable medium of claim 15, wherein the instructions, when executed by a processor, cause the processor to further perform:
projecting of residuals includes utilizing a numerical optimization to align the projected residuals with the two-dimensional representation of estimated continuous data values.

19. The non-transitory computer-readable medium of claim 18, wherein the projecting of residuals includes utilizing a numerical optimization to align the projected residuals with the two-dimensional representation of estimated continuous data values.

20. The non-transitory computer-readable medium of claim 15, wherein the instructions, when executed by a processor, cause the processor to further perform:
adjusting weights of a cross-entropy loss function based on class frequency to mitigate effects of class imbalance during the retraining of the time-series forecasting model.
